(19) United States
(12) Patent Application Publication
(10) Pub. No.: US 2009/0119708 A1
(43) Pub. Date: May 7, 2009

(54) USER INTERFACE DISPLAY WITHOUT OUTPUT DEVICE RENDERING

(75) Inventors: Derek T. Harrar, Devon, PA (US); John May, West Chester, PA (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/936,306

(22) Filed: Nov. 7, 2007

(51) Int. Cl. G06F 3/00; H04N 5/445; H04N 7/16; H04N 7/173

(52) U.S. Cl. 725/39; 715/716; 715/717; 725/133; 725/141; 725/38

(57) ABSTRACT

System and method for providing accessing to media available through a media output device. The access being facilitated through user interaction with user interface displayed on the media output device. The user interface may be displayed on the media output device without requiring the media output device to support graphical rendering associated with generating the user interface.

### BACKGROUND OF THE INVENTION

1. Field of the Invention

The present invention relates to providing user interfaces and related controls.

2. Background Art

Electronic programming guides (EPGs) and other user interfaces may be employed with media output devices and tuners to facilitate accessing services available through the media output device. The user interface may include a number of interactive features to facilitate navigating the user interface for the desired services. These features may be displayed through graphical renderings of buttons, menus, instructions, and other features associated with conveying information to a user.

The graphical rendering is traditionally undertaken by or at the tuner, whether the tuner is integrated with the media output device or is simply connected with the media output device. One example presents a settop box (STB) serving as both the tuner and the device for graphically rendering the user interface for display through a media output device such as a television or simple display monitor and supporting operations associated with user interaction with the interface. This requires the STB to not only perform processing associated tuning to selected channel frequencies but also to perform processing for graphically rendering the user interface and also processing associated with user interaction with the interface.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for providing electronic media and services in accordance with one non-limiting aspect of the present invention;

FIG. 2 illustrates a user interface in accordance with one non-limiting aspect of the present invention; and

FIG. 3 illustrates a flowchart of a method for limiting processing demands in accordance with one non-limiting aspect of the present invention.

### DETAILED DESCRIPTION OF THE PREFERRED EMBODIMENT(S)

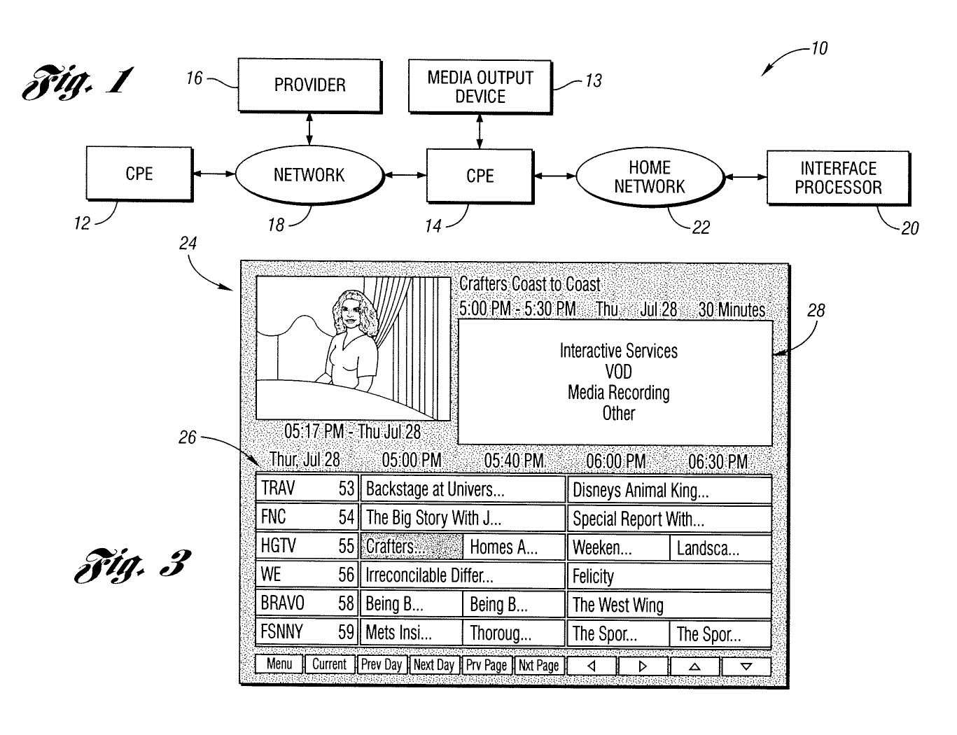

FIG. 1 illustrates a system 10 for providing or otherwise supporting delivery of electronic media and services in accordance with one non-limiting aspect of the present invention. The system 10 may include a number of pieces of customer premises equipment (CPE) 12, 14, a media provider 16, and a network 18. The system 10 may be generally referred to as a media content distribution network wherein media content is electronically transferred over the network 18 to the CPE 12, 14.

The media provider 16, for example, is most prominently described with respect to being a telecommunications service provider having capabilities for providing television, telecommunications, and/or data services to subscriber locations, primarily through wireline and/or wireless communications. The present invention, however, is not so limited and fully contemplates the provider 16 being associated with any type of service provider, including other television providers (IP, broadcast, satellite, etc.) and non-television providers, such as those associated with high-speed data, telecommunications, cellular communications, and the like.

The media provider 16 may be configured to support and/or facilitate the use of any number of television and non-television services and applications, such as, but not limited to email services, data transmission service, linear and non-linear television programming/signaling (cable, satellite, broadcast, etc.), Video on Demand (VOD), interactive television (iTV), interactive gaming, pay-per-view (PPV), digital video recording (local and remote), and/or broadcasting of signals associated with supporting television programming, movies, audio, and other multimedia, as well as, downloading of clips or full-length versions of the same.

The network 18 may include any number of features and devices to facilitate signal transportation and other operations associated with interfacing the subscriber locations with each other and otherwise supporting communications associated with services of the media provider 16. The network 18 may include terrestrial and orbital components and infrastructures, including copper, coaxial and/or fiber optic lines, and/or satellite or other wireless architectures. The network may be associated with other private and/or public networks, such as the Internet and dedicated or virtual private networks.

The CPE 12, 14 may relate to any device, element, and/or other feature associated with interfacing users with various services associated with the media provider, such as but not limited to a settop box (STB), a digital video recorder (DVR), a personal computer (PC), a television (which may include embedded user interface and processing capabilities), outlet digital adapter (ODA), media terminal adapter (MTA), cable modem (CM), personal digital assistant (PDA), mobile device (phone, computer, etc.), personal media device, and any other item having capabilities for supporting access to any number of the services.

The CPE 12, 14 may be configured to descramble and to support and/or facilitate the use of any number of protocols and/or formats for transmitting television and non-television related signals, such as, but not limited to, Hyper Text Transfer Protocol (HTTP), Internet Protocol (IP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

Media may be associated with and/or controlled by the media provider 16 (which in turn may receive the content from other sources). The media may be sourced from the media provider directly, from one or more of the subscriber devices 12, 14 connected to the network 18, such as but not limited to peer-to-peer environments, and/or from any other source in communication with the network 18 (internet, etc.). For example, if the media provider 16 is a television service provider, a portion of the media content may relate to television programs, movies, and other multimedia packets. The media content may be delivered to the subscriber locations directly from the media service provider 16 and/or from one or more of the other CPEs 12, 14 in communication with the network 18.

The system 10 may further include an interface processing element 20. The interface processing element 20 may be configured to support displaying user interfaces on the media output device 13, for example a television. For example, the CPE 12, 14 may be an STB which may be used to facilitate tuning to a specific channel frequency and descrambling (if necessary) the television signals transmitted on the frequency for output to the television. The user interfaces and other user interactive features associated with manipulating the user interface may be displayed on the television to facilitate accessing and otherwise interacting with available services. The STB is typically required to not only tune to the specific channel frequency but also to support graphical rendering and any number of other operations associated with the user interface. This can create extensive processing demands on the STB.

One non-limiting aspect of the present invention contemplates ameliorating or otherwise limiting these processing demands by shifting the related processing demands to the interface processing element 20, and optionally eliminating the need for the STB. The interface processing element 20 may be able to limit user interface related processing demands on the CPE 12, 14 so that the CPE 12, 14 no longer needs to perform graphical rendering and other processes associated with displaying and executing operations related to the user interface. This includes alleviating the CPE 12, 14 from having to generate graphics included within the user interface and from having to perform database queries for guide data or other data (text) shown in the user interface.

The interface processing element 20, optionally, may be attached to a home network 22 associated with the CPE 14 such that it is local to the CPE 14. The interface processing element 20 may be incorporated into a personal computer and/or other device in the home or in communication therewith having capabilities consistent with executing operations associated with the scope and contemplation of the present invention. Software and/or other logic may be downloaded from the provider 16 to the interface processing element 20 to facilitate operations associated with generating the user interfaces. In this manner, one non-limiting aspect of the present invention allows providers to leverage a user's home network processing capabilities to support provider related services.

Hereinafter, the present invention is predominately described with respect to displaying an interactive user interface associated with facilitating television related interactive services without requiring the STB (or television, if the television itself tunes to a specific channel frequency and descrambles television signals without the use of an STB) to graphically render the user interface. The present invention is not, however, intended to be limited to user interfaces associated with supporting televisions and displaying the user interfaces on televisions. The present invention fully contemplates its application in any number of environments where it may be advantageous to limit processing demands on particular devices.

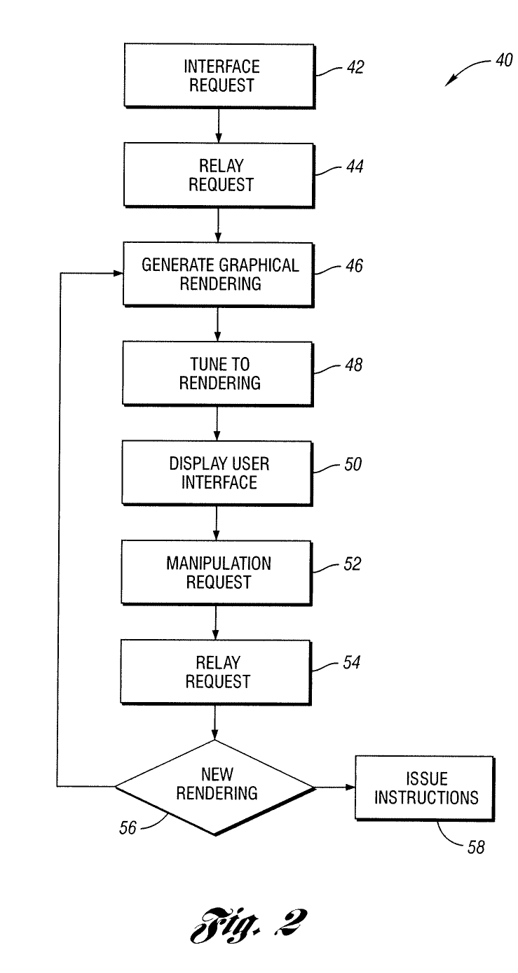

FIG. 2 illustrates a user interface 24 in accordance with one non-limiting aspect of the present invention. The user interface 24 presents a graphical rendering that may be displayed on a television or other media output device in order to access services and other features available to the user from a service provider or other resource. The user interface graphically displays any number of navigation menus that may be selected to perform any number of related operations.

A remote control (not shown) or similar device may be used to interact with the user interface in order to navigate through the menus. For example, the user interface 24 may be an electronic programming guide (EPG) employed by television service providers to enable subscribers to access various provider related services.

The illustrated user interface 24 includes a channel grid 26 for selecting channels and their associated programs and a menu 28 having selectable features, such as interactive services, video on-demand (VOD), media recording, other, etc., for accessing other services and navigating to corresponding user interfaces. Of course, the user interface may include any number of other menus, buttons, and features, as well as other media, such as but not limited to moving images, advertisements, etc.

Unlike the EPG-related user interfaces that rely on STBs (or the television, as the case may be) to support the associated graphical rendering and interactive operations, one non-limiting aspect of the present invention contemplates performing the processing related to the graphical rendering of the user interface on the interface processing element 20. The present invention contemplates facilitating display of the user interface 24 by simply transmitting the data representing the user interface from the interface processing element 20 to the STB and then to the media output device (television) or directly to the media output device (if it incorporates a tuner). The transmission of the user interface data may take place over any type of communications channel or medium.

The interface processing element 20 may be configured to execute the associated graphical renderings and processing demands associated with user interaction with the user interface 24 such that the STB or television (if it incorporates a tuner) need only tune to the channel frequency showing the selected programming, and if related controls from user interaction or other processing demands are made, the interface processing element 20 can execute the related operations and change the user interface accordingly and/or issue instructions to the tuner to perform the related processes such that the tuner is instructed to take action without having to determine or process information related to taking the action.

The interface processing element 20 may be configured to generate the user interface graphical renderings and to output them in television signals that may be tuned to by the television to display the corresponding user interface 24 such that the television need only tune to the signals to display the user interface 24. Commands, selections, and other user interactions made with respect to the tuned to user interface may be relayed by the television to the processing element for execution. The processing element 20 may then provide instructions to the television or take other associated with the execution thereof.

FIG. 3 illustrates a flowchart 40 of a method for limiting processing demands in accordance with one non-limiting aspect of the present invention. The method generally relates to processing demands associated with displaying or otherwise supporting the display of a user interface on a television or other media output device. This may include limiting processing demands on the STB or television (if it incorporates the STB) or other device connected thereto that is used to tune a specific channel frequency and/or descramble or otherwise process signals associated with the available services, including outsourcing the processing demands associated with generating graphics for a user interface and processing demands associated with executing commands related to manipulation of the user interface.

Typically, the processing demands for generating graphics for a user interface and executing commands related to manipulation of the user interface and updating the graphics for the user interface in response to executing the commands are sourced to the STB or television (if the television incorporates the features of the STB). The present invention shifts the processing for generating the user interface, rendering the user interface graphics, executing commands related to the user interface and generating and rendering graphics in response to the commands to a device which is remote from the tuner. This remote device can be connected to the tuner directly or through a home network. In this manner, the tuner can be a fairly simple device and the user interface processing can take place on a device which already has the computing power to carry out the desired tasks. A home desktop or laptop computer are two examples of such device.

Block 42 relates to determining a user interface related request. The user interface related request includes any request associated with accessing services provided by the media provider, including but not limited to service requests of the type commonly initiated through the user interface shown in FIG. 2 or other user interfaces associated with the provided services. This may include selection of guide, information, or other button on a remote control or other device used to control the media output device (television). The user interface related request may relate to any request for display or access to any type of user interface used to access available services.

Block 44 relates to relaying the interface related request to the interface processing element. This may include the tuner (STB or television (if it incorporates the STB features and functions) or other device associated with the television) receiving the interface related request and then transmitting the request to the interface processing element. The interface related request may be relayed without any processing by the tuner (STB and/or the television), however, other information may be added, such as but not limited to information associated with identifying the television and its location on a home network and/or other information that may be helpful or necessary to facilitate generating the desired user interface.

Block 46 relates to the interface processing element processing the request relayed from the tuner. The interface processing element may perform graphical renderings, communicate with the media provider, download data and other information, and/or perform any number of other operations necessary to facilitate display of a user interface corresponding with the interface related request. For example, if the request is associated with displaying a user interface of the type shown in FIG. 2, the interface processing element performs the graphical rendering associated with displaying the illustrated menus and features.

The interface processing element may perform other operations associated with displaying the user interface. This may include contacting the media provider to determine viewing rights and other entitlements of the requesting entity to determine appropriate features and options for the user interface. For example, the interface processing element may download a channel map associated with the geographical area of the requesting entity, a listing of videos purchased and available on-demand for the requesting entity, a listing of viewing preferences, a listing suitable user interface advertisement, etc. This information may then be included with or otherwise used to facilitate constructing and/or editing the user interface.

Once the interface processing element collects and processes the necessary information, it may output signals associated with displaying the corresponding user interface. The signals may be formatted to correspond with operations of the media output device having limited processing demands. For example, if the device is a television, the signals may be translated into television signals carried over a channel that can be tuned by the television for displaying the user interface, as if the television were tuning to a channel broadcasted by the media provider. The signals may also be packed into a message, file, or other suitable medium for communication to and display by the media output device.

Block 48 relates to the media output device locating the user interface related signals transmitted from the interface processing element. The interface processing element may provide instructions or other messages to the media output device to facilitate locating the signals. If the signal are carried in television channel, for example, the instructions may be used to facilitate tuning the media device to the associated television channel. The interface processing element may stream or otherwise broadcast the signals over the channel for receipt by the media output device.

Block 50 relates to the media output device displaying the user interface. This may include the media output device simply tuning to the specified channel and displaying the user interface as if it were a normal television program. The media output device may be instructed to automatically tune to the channel showing the user interface upon receipt of the signals from the interface processing element. This may require the media output device to change channels or perform other operations associated with switching from the currently watched channel to the signals showing the user interface.

Block 52 relates to determining a manipulation request. The manipulation request may be determined after the user interface is displayed and corresponds with any user interaction requiring changes to the display. This may include changing the highlighted cell, requesting access to another menu, ordering an on-demand program, setting a media recording, and any other operation wherein information within the user interface is changed and/or if the user interface is to be removed, i.e., if the user desires to exit the user interface. If the user desires to exit the user interface, the processing element may issue an instruction to tune the media output device back to the previously tuned channel.

Block 54 relates to relaying the manipulation request to the interface processing element. This request may be transmitted in a manner similar to that described above with respect to the initial interface related requested. It may be beneficial to expedite transmission of the request so that changes to the user interface can take place as quickly as possible in order to simulate real-time control of the cursor and other interactions with the user interface.

Block 56 relates to determining whether the manipulation request requires re-rendering the user interface or some other operation. The re-rendering generally relates to any display changes to the user interface which require the interface processing element to render new graphics for transmission to the media output device. The re-rending requests may relate to other commands, such as a channel change request, a video demand order, etc.

Blocks 46-54 are repeated if the request requires re-rendering such that the appropriate information is ascertained in the displayed information is altered to correspond with the request. This may be repeatedly executed as the user navigates through the user interface, such as if the user is ‘flipping’ through the programs shown in programming guide portion of the user interface. Block 58 is reached if the request relates to a command where the interface processing element may need to take some other action beside changing the displayed information.

If the command relates to a channel change operation, Block 58 may relate to the interface processing element issuing instructions to the tuner to tune to a different channel. If the command relates to setting a media recording event, Block 58 may relate to the interface processing element issuing instructions to a digital video recorder or other device connected thereto to begin recording immediately or to start recording at a specified time. Optionally, the instructions may be issued in combination with the interface processing element changing the user interface.

The interface processing element may be required to execute other operations before issuing the instructions. If the manipulation request relates to ordering a movie on-demand, for example, the interface processing element may engage in an exchange with the media provider or a VOD server to facilitate delivery of the movie to the media output device. The interface processing element may coordinate all processes associated with ordering the movie so that it can simply instruct the tuner to tune to a particular channel frequency on which the movie will be available for viewing.

The interface processing element may be required to monitor operation even after issuing the instructions and completing the manipulation request. With respect to ordering a movie on demand or for other interactive services, the interface processing element may coordinate related interactive controls, such as pause, fast forward, rewind, etc. This may include the tuner relaying the associated control signals to the interface processing element and the interface processing element then subsequently relaying the control signals to the VOD server or taking other action associated therewith.

One non-limiting aspect of the present invention relates to a home network converged media application architecture where home network resources may be utilized to support services associated with a media service provider. One example is a PC connected to the home network to support EPG functionality and processing that is typically supported on the STB. This allows one to reduce processing demands on the STB.

One non-limiting aspect of the present invention relates to having the TV user interface (UI) “run” on the PC and be rendered on the TV. That way, the UI, EPG, interactive application, etc. can be unencumbered by the constraints of the STB in terms of memory, processing, software development, etc. The STB could literally become a simple tuner that tunes to different “channels” or frequencies. Furthermore, since the guide data may be stored on the PC, this information could be combined seamlessly with Internet-sourced video content in a consistent UI. When the viewer is surfing through the TV UI/EPG, they can be presented media content from any source in a consistent and seamless experience, regardless of whether a linear asset is streamed through the headend or from the Internet (or anywhere else) or time shifted content is coming from a local drive, a network/VOD drive, launched off of an Internet website, etc. Furthermore, interactive applications, games, etc. could run on the PC and be rendered on the TV.

With respect to EPGs, for example, channel maps, data, advertisements, and any number of other features may be downloaded to a computer for processing and used in supporting the EPG. The EPG may be a simple web page, portal or other feature accessible through the STB. The PC functionality may also be used to provide enhanced EPGs and interfaces not previously possible given the limited processing capabilities of most STBs. The STB may be stripped bare, such as to nothing but conditional access and features to view the EPG page supported on the PC. Remote control signals to the STB may be routed to the PC for controlling the EPG.

One non-limiting aspect of the present invention relates to allowing the customer to view EPGs on multiple devices within a home, and with devices which may not have a STB or other feature suitable to processing user interfaces, such as with a television connected directly to the cable line. Each room may also be supplied with different EPGs depending on the capabilities of the corresponding viewing device. This may allow users in different rooms of the home to interact with user interfaces even though the television are themselves incapable of supporting the user interface as the television can be instructed to tune to dedicated channel showing a user interface for the corresponding television.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of generating and displaying a user interface on a display device for facilitating user interface related operations, the method comprising:
receiving an interactive user interface operation request at a user input receiver;
relaying the request from the user input receiver to an interface processing element located remotely from the user input receiver;
generating user interface information for creating the user interface and running the user interface at the interface processing element;
transmitting the user interface information to the user input receiver; and
using the user interface information for rendering the user interface on the display device.

2. The method of claim 1 wherein relaying the operation request from the user input device to the interface processing element occurs over a home network.

3. The method of claim 1 further comprising receiving a manipulation request at the user input receiver the manipulation request associated with user interaction with the currently displayed user interface, relaying the manipulation request to the interface processing element, executing the manipulation request at the processing element, generating new user interface information in response to the execution of the manipulation request, transmitting the new user interface information to the user receiver and using the new user interface information for rendering the user interface on the display.

4. The method of claim 3 further comprising supporting execution of the manipulation request with the processing element altering the television signals to change information displayed in the user interface to correspond with information associated with the manipulation request.

5. The method of claim 3 wherein the manipulation request relates to accessing media from a media provider located remotely from the processing element and the television, wherein the method further comprises the processing element receiving instructions from the media provider to facilitate accessing the media and thereafter transmitting related instructions for use by the television in accessing the media.

6. The method of claim 3 wherein the manipulation request relates to recoding media on a recording device associated with the television, wherein the method further comprises the processing element providing instructions to the recording device to facilitate recording the media.

7. The method of claim 3 wherein the manipulation request relates to tuning to a channel listed in the user interface, wherein the method further comprises the processing element providing instructions to the television to facilitate tuning to the channel.

8. A method of displaying user interfaces on a number of media output devices in common communication with a home network, the method comprising:
generating a unique user interface for each media output device with an interface processing element in communication with the home network; and
transmitting signals associate with displaying the user interfaces to the media output devices such that each media output device displays a different one of the unique user interfaces.

9. The method of claim 8 further comprising transmitting the signals within television channels broadcasted over the home network from the interface processing element.

10. The method of claim 9 further comprising transmitting signals for each user interface over different television channels such that each television channel only includes signals for one user interface.

11. The method of claim 9 further comprising transmitting instructions to the media output devices to facilitate automatically tuning the media output devices to the television channels.

12. The method of claim 8 further comprising changing the transmitted signals as a function of user interaction with the user interfaces so as to simulate real-time control of the user interfaces.

13. A method of displaying an electronic programming guide (EPG) on a display device, the method comprising:
controlling the television to tune to signals carried over a television channel showing the EPG; and
changing the signals carried over the television channel to correspond with user interaction with the EPG.

14. The method of claim 13 further comprising issuing instructions to control operations of the television as a function of user interaction with the EPG.

15. The method of claim 13 further graphically rendering images associated with the EPG with an interface processing element connected to a home network associated with the television.

16. A system for providing media services associated with a media service provider to a subscriber home having a display device, wherein the display device is associated with a home network of the subscriber, the system comprising:
an interface processing element associated with the home network, the interface processing element configured to generate user interface information for creating the user interface and running the user interface thereon and transmit the user interface information to the display device via the home network; and
wherein the display device is configured to receive the user interface information and render the user interface using the user interface information.

17. The system of claim 16 further comprising issuing instructions from the interface processing element to the media device to facilitate controlling the media device to access media service selected through the user interfaces.

18. The system of claim 17 wherein the instructions facilitate accessing the media services from signals carried over a provider network, the provider network being separate from the home network and common to the media output devices.

19. The system of claim 17 wherein the subscriber includes multiple media devices in communication with the home network and the interface processing element associated therewith broadcast signals to support different user interface for each media device on the home network.

20. The system of claim 17 wherein the interface processing element is configured to provide real-time control of the user interfaces.

21. The system of claim 17 wherein the interface processing element is configured to vary the user interfaces a function signals relied thereto from the media output device.

22. A system for displaying a user interface on a television without requiring a tuner or settop box (STB) of the television to generate graphics included within the user interface, the system comprising:
a home network in communication with the television; and
a computer connected to the home network and configured to transmit television signals over the home network, the tuner or STB being capable of tuning to the television signals for display, the computer configured to transmit the user interface within the television signals such that the tuner or STB can display the user interface by tuning to the television signals and without having to generate the graphics associated therewith.

23. The system of claim 22 wherein the television is configured to relay a manipulation request associated with user directed manipulation of the displayed user interface to the computer, the computer changing the graphics shown in the user interface and re-transmitting the television signals if the manipulation request requires re-rendering the graphics.

24. The system of claim 22 further comprising a second television in communication with the home network and the computer wherein the computer is configured to generate unique user interfaces to each television and to transmit each user interface over the home network within television signals carried in different television channels.
